(19) United States
(12) Patent Application Publication
(10) Pub. No.: US 2018/0211765 A1
(43) Pub. Date: Jul. 26, 2018

(54) THIN INDUCTOR

(71) Applicant: Murata Manufacturing Co., Ltd., Nagaokakyo-shi (JP)

(72) Inventors: Masataka NAKANIWA, Nagaokakyo-shi (JP); Hirokazu YAZAKI, Nagaokakyo-shi (JP)

(21) Appl. No.: 15/933,515

(22) Filed: Mar. 23, 2018

Related U.S. Application Data
(63) Continuation of application No. PCT/JP2016/086296, filed on Dec. 7, 2016.

(30) Foreign Application Priority Data
Dec. 25, 2015 (JP) 2015-255167

(51) Int. Cl. H01F 27/29; H01F 17/00; H01F 27/28

(52) U.S. Cl. CPC H01F 27/292; H01F 17/0013; H01F 2027/2809; H01F 17/0033; H01F 27/2804

(57) ABSTRACT

A surface-mount thin inductor includes a rectangular or substantially rectangular thin sheet body, loop conductor patterns each with a winding axis in a direction in which base layers in the body are stacked, and four surface electrodes that are on a first main surface of the body. A center of each of the four surface electrodes is located in a region in which the loop conductor patterns are located when viewed in a stacking direction. The four surface electrodes are disposed separately at four corners of the first main surface of the body.

### CROSS REFERENCE TO RELATED APPLICATIONS

This application claims the benefit of priority to Japanese Patent Application No. 2015-255167 filed on Dec. 25, 2015 and is a Continuation Application of PCT Application No. PCT/JP2016/086296 filed on Dec. 7, 2016. The entire contents of each application are hereby incorporated herein by reference.

### BACKGROUND OF THE INVENTION

### 1. Field of the Invention

The present invention relates to a surface-mount ultra-thin inductor, and more particularly to a thin inductor that has a thickness of about 0.5 mm or less and that reduces a degree of inhibition of formation of a magnetic field due to surface electrodes.

### 2. Description of the Related Art

Various electronic devices include inductors, each of which includes a coil conductor in a body defined by base layers that are stacked. Such an inductor is disclosed in International Publication No. WO2013/128702. FIG. 7 illustrates an inductor (stack-type inductor) 500 disclosed in International Publication No. WO2013/128702. The inductor 500 includes a body 101 formed of magnetic base layers (magnetic-material layers) 101a to 101h. As illustrated in FIG. 7, the base layers 101b and 101g have a thickness larger than the thickness of the other base layers 101a, 101c to 101f, and 101h. Loop conductor patterns (line conductors) 102a to 102e and wiring conductors 103a and 103b are disposed between the base layers 101a to 101h. Via conductors (interlayer connection conductors) 104 are defined through the base layers 101a to 101g so as to extend between both main surfaces thereof. A pair of surface electrodes (external connection conductors) 105a and 105b are formed on one of the main surfaces (lower main surface) of the body 101. In the inductor 500, a coil is provided in a manner in which via the conductors 104 connect the surface electrode 105a, the loop conductor patterns 102a to 102e, the wiring conductors 103b and 103a, and the surface electrode 105b in this order.

A decrease in size of electronic components including inductors is a very important problem in the wake of a decrease in size of electronic devices. For example, IC-card-type devices need thin inductors having a thickness of about 0.5 mm or less. However, there is a problem in that, when an inductor having a thickness of about 0.5 mm or less is manufactured so as to have a conventional inductor structure such as the structure of the inductor 500 disclosed in International Publication No. WO2013/128702, it is difficult for the inductor to have a large inductance value and a high Q factor. That is, it is necessary to decrease the thickness of the base layers 101b and 101g illustrated in FIG. 7 to decrease the thickness of the inductor 500 disclosed in International Publication No. WO2013/128702 to 0.5 mm or less. That is, it is difficult to manufacture an inductor having a thickness of about 0.5 mm or less unless the thickness of the base layers 101b and 101g is decreased at least to substantially the same thickness of the other base layers 101a, 101c to 101f, and 101h or the number of the loop conductor patterns 102a to 102e is decreased.

However, the decrease in the number of the loop conductor patterns 102a to 102e makes it difficult to obtain a large inductance value. The decrease in the thickness of the base layers 101b and 101g that face a coil opening decreases distances between the loop conductor pattern 102a and the surface electrodes 105a and 105b. When the distances between the loop conductor pattern 102a and the surface electrodes 105a and 105b are short, the surface electrodes 105a and 105b inhibit the loop conductor patterns 102a to 102e from forming a magnetic field, and the inductor 500 cannot have a high Q factor. In particular, the surface electrodes 105a and 105b of the inductor 500 each have a large area, and accordingly, the decrease in the distances between the loop conductor pattern 102a and the surface electrodes 105a and 105b increases the effect of the surface electrodes 105a and 105b to inhibit the formation of the magnetic field.

When the inductor 500 is viewed in a stacking direction of the body 101, the surface electrodes 105a and 105b considerably overlap a cavity (region inside a region in which the loop conductor patterns 102a to 102e are formed) of the coil, and accordingly, the decrease in the distances between the loop conductor pattern 102a and the surface electrodes 105a and 105b significantly increases the effect of the surface electrodes 105a and 105b to inhibit the formation of the magnetic field. That is, the cavity of the coil is a region on which the magnetic flux generated by the loop conductor patterns 102a to 102e is most concentrated. This region is blocked by the surface electrodes 105a and 105b. Consequently, there is a problem in that the magnetic field is greatly inhibited from being formed, and the Q factor is greatly decreased.

Thus, one of the problems described above is that an inductor having a conventional structure and a decreased thickness (0.5 mm or less) cannot have a sufficiently large inductance value and Q factor.

### SUMMARY OF THE INVENTION

Preferred embodiments of the present invention provide surface-mount thin inductors including a rectangular or substantially rectangular thin sheet body that is defined by base layers stacked and that has a thickness of about 0.5 mm or less, a coil conductor that is disposed in the body and that has a winding axis in a direction in which the base layers are stacked, and four surface electrodes that are on a first main surface of the body. A first end of the coil conductor is connected to at least one of the surface electrodes, and a second end of the coil conductor is connected to at least one of the other surface electrodes. A center of each of the four surface electrodes is located in a region in which the coil conductor is provided when viewed in the direction in which the base layers are stacked.

The region in which the coil conductor is provided is a region having a width corresponding to a distance between an inner circumferential edge and an outer circumferential edge of the coil conductor in a plan view (when viewed in the direction in which the base layers are stacked).

The coil conductor is provided by a loop conductor pattern or loop conductor patterns that are connected to each other by using interlayer connection conductors such as via conductors, for example. It suffices that the thin inductor includes at least four surface electrodes. That is, the number of the surface electrodes of the thin inductor is not limited to four and may be five, or six or more.

The four surface electrodes are preferably disposed separately at four corners of the first main surface of the body. In this case, the first main surface of the body is stable when the thin inductor is mounted.

Each of the four surface electrodes preferably does not overlap an opening of the coil conductor, or overlaps the opening of the coil conductor with an overlapping area being equal to or less than about 10% of an area of the surface electrode when viewed in the direction in which the base layers are stacked. This further reduces the effect of the surface electrodes to inhibit the formation of the magnetic field, and significantly reduces or prevents a decrease in the Q factor.

The first end of the coil conductor is preferably connected to two surface electrodes of the surface electrodes, and the second end of the coil conductor is preferably connected to the other two surface electrodes. In this case, each of the ends of the coil conductor is connected to land electrodes of the outside (for example, a substrate) by using the corresponding two surface electrodes, and this ensures electric connections and decreases a resistance component.

A first distribution electrode and a second distribution electrode are preferably disposed between the base layers near the first main surface of the body, the first end of the coil conductor is preferably connected to the first distribution electrode, the first distribution electrode is preferably connected to the two surface electrodes, the second end of the coil conductor is preferably connected to the second distribution electrode, and the second distribution electrode is preferably connected to the other two surface electrodes. In this case, the first end of the coil conductor is able to be easily connected to the two surface electrodes, and the second end of the coil conductor is able to be easily connected to the other two surface electrodes.

In this case, the first distribution electrode and the second distribution electrode are preferably disposed mainly in the region in which the coil conductor is provided when viewed in the direction in which the base layers are stacked. This reduces the effect of the first distribution electrode and the second distribution electrode to inhibit the formation of the magnetic field.

The first end of the coil conductor may be connected to one of the surface electrodes, the second end of the coil conductor may be connected to one of the other surface electrodes, and the other two surface electrodes to which the coil conductor is not connected may be first dummy surface electrodes that have no electrical connection. In this case, the first dummy surface electrode increases a mounting strength.

Another thin inductor according to a preferred embodiment of the present invention includes a rectangular or substantially rectangular thin sheet body that is defined by base layers stacked and that has a thickness of about 0.5 mm or less, a coil conductor that is disposed in the body and that has a winding axis in a direction in which the base layers are stacked, and four surface electrodes that are provided on a first main surface of the body. A first end of the coil conductor is connected to two surface electrodes of the four surface electrodes, and a second end of the coil conductor is connected to the other two surface electrodes. The four surface electrodes are disposed separately at four corners of the first main surface of the body.

A second dummy surface electrode that has no electrical connection and that increases a mounting strength is preferably near a center of the first main surface of the body. In this case, the second dummy surface electrode increases the strength of mounting to a printed circuit board. The second dummy surface electrode has no electric connection and is not connected to either of a signal line or the ground after being mounted on, for example, a substrate. Accordingly, the second dummy surface electrode does not greatly inhibit the magnetic field from being generated although the second dummy surface electrode is disposed near the center of the first main surface of the body.

The second dummy surface electrode is preferably divided into plural second dummy surface electrodes. In the case where the second dummy surface electrode is not divided and has a large area, there is a risk that, when the second dummy surface electrode is soldered to, for example, a land electrode of a substrate, the film thickness of the solder becomes too big, and this causes a mounting failure of the thin inductor. However, in the case where the second dummy surface electrode is divided into plural second dummy surface electrodes, the area of each of the divided second dummy surface electrodes is decreased, the film thickness of the solder when each second dummy surface electrode is soldered is decreased, and the occurrence of a mounting failure is significantly reduced or prevented. In addition, the divided second dummy surface electrodes are unlikely to inhibit the formation of the magnetic field.

The body is preferably made of ceramics, and a third dummy surface electrode that has no electrical connection is preferably on a second main surface of the body. The body made of ceramics needs a firing process in manufacturing processes. In the case where the electrodes (for example, the surface electrodes) are only on the first main surface of the body and no electrodes are provided on the second main surface of the body, a difference in coefficient of thermal shrinkage arises between both main surfaces, the behavior of firing changes therebetween, and the body (sintered body) after firing is likely to warp particularly in the case of very thin ceramics. However, the third dummy surface electrode provided on the second main surface of the body inhibits the body from warping during the firing process.

In this case, the thin inductor preferably includes a plurality of the third dummy surface electrodes, the plurality of the third dummy surface electrodes are preferably arranged so as to overlap the surface electrodes, are arranged so as to overlap the surface electrodes and the first dummy surface electrode, are arranged so as to overlap the surface electrodes and the second dummy surface electrode, or are arranged so as to overlap the surface electrodes, the first dummy surface electrode, and the second dummy surface electrode when viewed in the direction in which the base layers are stacked. In this case, the degree of inhibition of the formation of the magnetic field due to these electrodes is able to be reduced to the minimum. That is, in the case where the third dummy surface electrodes are arranged so as not to overlap the surface electrodes and other electrodes, a portion of the magnetic flux generated by the coil conductor is blocked by the surface electrodes and other electrodes on the first main surface of the body, and another portion of the magnetic flux generated by the coil conductor is blocked by the third dummy surface electrodes on the second main surface of the body. Consequently, these electrodes greatly inhibit the magnetic field from being generated. However, in the case where the third dummy surface electrodes are arranged so as to overlap the surface electrodes and other electrodes, although the portion of the magnetic flux blocked by the surface electrodes and other electrodes on the first main surface of the body is also blocked by the third dummy surface electrodes on the second main surface of the body, a portion of the magnetic flux that is not blocked by the surface electrodes and other electrodes on the first main surface of the body is also not blocked by the third dummy surface electrodes on the second main surface of the body. That is, the portion of the magnetic flux blocked by the surface electrodes and other electrodes on the first main surface of the body is common to the portion of the magnetic flux blocked by the third dummy surface electrodes on the second main surface of the body, and a sufficient amount of the magnetic flux that is blocked neither by the surface electrodes and other electrodes on the first main surface of the body nor by the third dummy surface electrodes on the second main surface of the body is able to be ensured to reduce the degree of inhibition of the formation of the magnetic field due to these electrodes to the minimum.

The base layers of the body are preferably made of magnetic base layers and at least one non-magnetic base layer, and the non-magnetic base layer is preferably interposed and stacked between two of the magnetic base layers. In the case where the body is made of the magnetic base layers only, magnetic saturation is likely to occur when a large direct current flows, and there is a risk that an inductance value suddenly decreases. However, the at least one non-magnetic base layer thus stacked in the coil conductor improves DC superposition characteristics. Magnetic saturation is unlikely to occur even when a large direct current flows, and the inductance value is inhibited from suddenly decreasing.

The body is preferably made of ceramics, at least one layer of a gap extending in a direction perpendicular or substantially perpendicular to the direction in which the base layers are stacked is preferably provided in the body, and the gap preferably overlaps the region in which the coil conductor is provided when viewed in the direction in which the base layers are stacked. The body made of ceramics needs the firing process in the manufacturing processes. During cooling after firing, a stress may be produced between the base layers and the coil conductor due to a difference in the coefficient of thermal shrinkage, and there is a problem of degradation of magnetic characteristics (for example, a decrease in magnetic permeability) due to stress strain of the body after firing. However, the at least one layer of the gap thus provided in the base layers relieves the stress produced between the base layers and the coil conductor, and significantly reduces or prevents the degradation of the magnetic characteristics.

In a thin inductor according to a preferred embodiment of the present invention, the center of each of the four surface electrodes is located in the region in which the coil conductor is provided when viewed in the direction in which the base layers are stacked. Accordingly, the degree of inhibition of the formation of the magnetic field due to the surface electrodes is reduced to the minimum, even though the thickness is about 0.5 mm or less.

In another thin inductor according to a preferred embodiment of the present invention, the first end of the coil conductor is connected to two surface electrodes of the four surface electrodes, and the second end of the coil conductor is connected to the other two surface electrodes. The four surface electrodes are disposed separately at four corners of the first main surface of the body. Accordingly, the degree of inhibition of the formation of the magnetic field due to the surface electrodes is reduced to the minimum, even though the thickness is about 0.5 mm or less.

The thin inductors according to preferred embodiments of the present invention are firmly secured to external electrodes (such as land electrodes of substrates) by using the four surface electrodes even when the area of each surface electrode is decreased, and a decrease in the mounting strength is able to be significantly reduced as much as possible or prevented.

The above and other elements, features, steps, characteristics and advantages of the present invention will become more apparent from the following detailed description of the preferred embodiments with reference to the attached drawings.

### BRIEF DESCRIPTION OF THE DRAWINGS

FIGS. 1A and 1B illustrate perspective views of a thin inductor 100 according to a first preferred embodiment of the present invention. FIG. 1A illustrates the thin inductor 100 from an upper main surface side (second main surface side). FIG. 1B illustrates the thin inductor 100 from a lower main surface side (first main surface side).

FIG. 2 is an exploded perspective view of the thin inductor 100.

FIGS. 3A and 3B illustrate perspective views of the thin inductor 100 from the lower main surface side (first main surface side).

FIG. 4 is an exploded perspective view of a main portion of a thin inductor 200 according to a second preferred embodiment of the present invention.

FIG. 5 is an exploded perspective view of a thin inductor 300 according to a third preferred embodiment of the present invention.

FIG. 6 is a perspective view of a thin inductor 400 according to a fourth preferred embodiment of the present invention. The thin inductor 400 is illustrated from the lower main surface side (first main surface side).

FIG. 7 is an exploded perspective view of an inductor 500 disclosed in International Publication No. WO2013/128702.

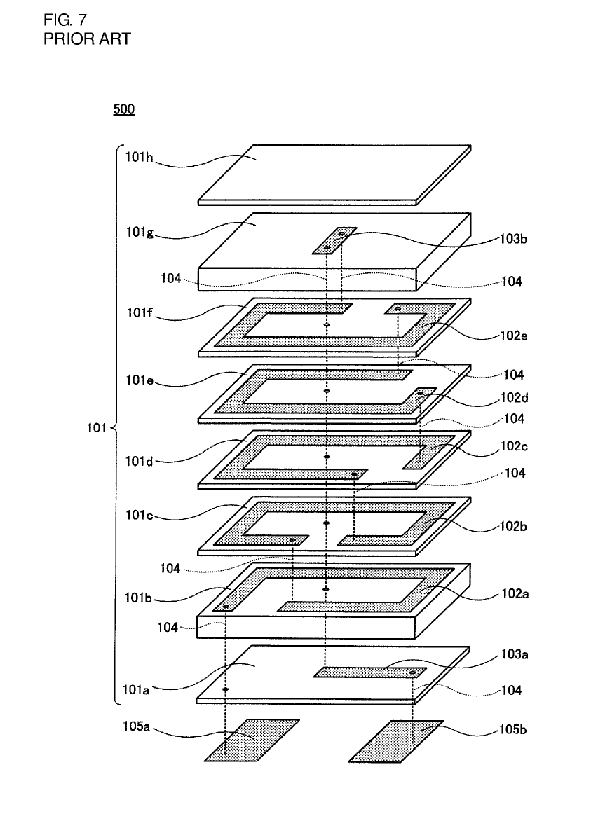

### DETAILED DESCRIPTION OF THE PREFERRED EMBODIMENTS

Preferred embodiments of the present invention will hereinafter be described with reference to the drawings.

The preferred embodiments of the present invention are described by way of example, and the present invention is not limited to the contents of the preferred embodiments. The contents described according to the preferred embodiments can be combined. In this case, the contents to be carried out are included in the present invention. The drawings assist in understanding the preferred embodiments and are not necessarily made precisely. For example, in some cases, the ratio of dimensions of a component or between components in the drawings does not match the ratio of the dimensions thereof in the description. In some cases, a component in the description is omitted in the drawings, and the number thereof is omitted in the drawings.

### First Preferred Embodiment

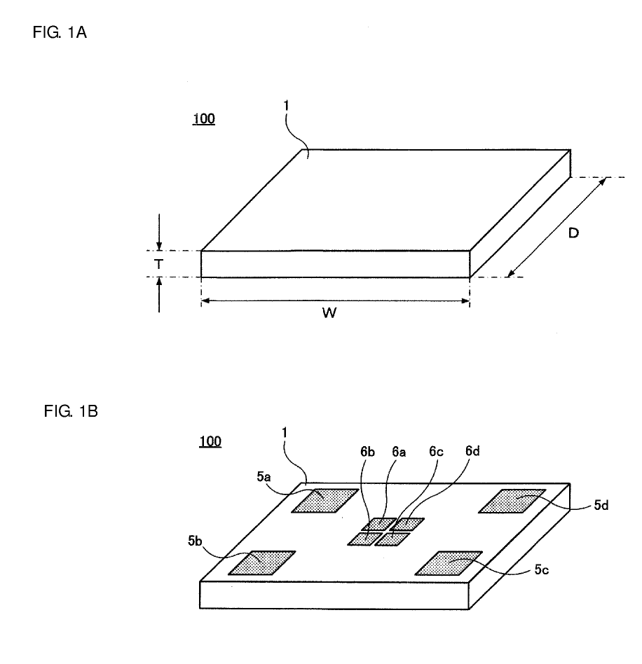

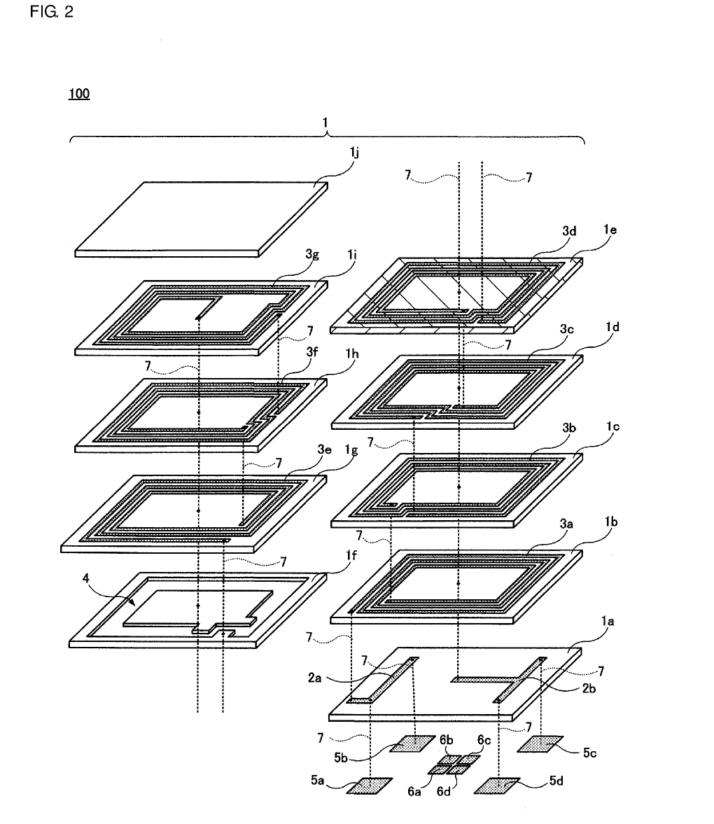

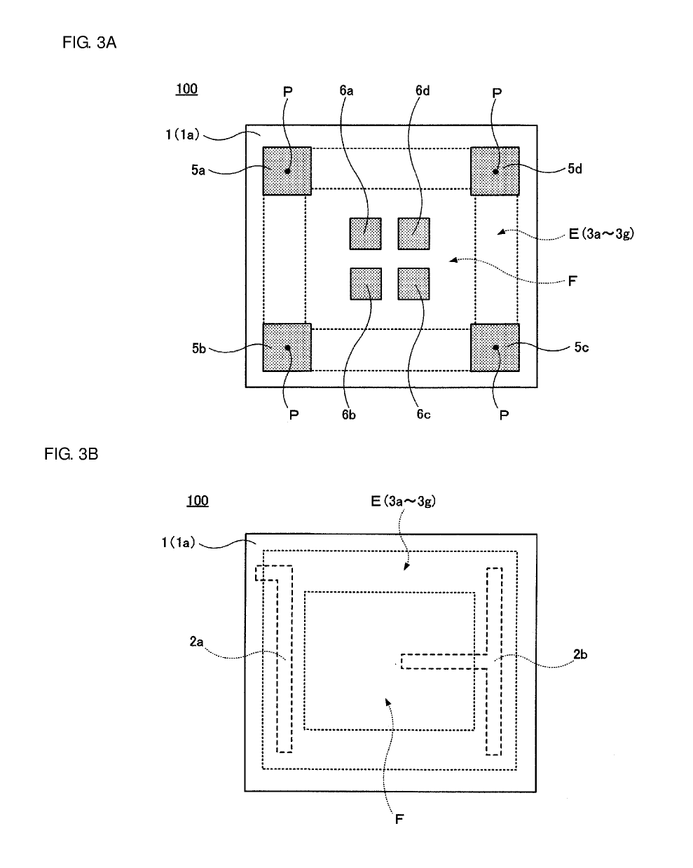

FIGS. 1A and 1B, FIG. 2, and FIGS. 3A and 3B illustrate a thin inductor 100 according to a first preferred embodiment of the present invention. FIGS. 1A and 1B illustrate perspective views of the thin inductor 100. FIG. 2 is an exploded perspective view of the thin inductor 100. FIGS. 3A and 3B illustrate perspective views of the thin inductor 100 from a lower main surface side (first main surface side).

The thin inductor 100 includes a body 1. According to the present preferred embodiment, the external dimensions of the body 1 illustrated in FIGS. 1A and 1B preferably are, for example, about 3.5 mm in width W, about 3.2 mm in depth D, and about 0.35 mm in thickness T, and the body 1 is very thin. Thin inductors according to the present invention preferably each have a thickness T of about 0.5 mm or less, a width W of about 2.0 mm to 10.0 mm, and a depth D of about 2.0 mm to about 10.0 mm, for example, which are very thin inductors.

The body 1 is made of magnetic base layers 1a to 1d, a non-magnetic base layer 1e, and magnetic base layers 1f to 1j that are stacked in this order from the bottom. The non-magnetic base layer 1e is made of ceramics having low magnetic permeability or non-magnetic ceramics. The magnetic base layers 1a to 1d and 1f to 1j are each made of magnetic ceramics such as ferrite having magnetic permeability larger than that of the non-magnetic base layer 1e.

A first distribution electrode 2a and a second distribution electrode 2b are located between the magnetic base layer 1a and the magnetic base layer 1b. A loop conductor pattern 3a is provided in three turns between the magnetic base layer 1b and the magnetic base layer 1c. A loop conductor pattern 3b is provided in three turns between the magnetic base layer 1c and the magnetic base layer 1d. A loop conductor pattern 3c is provided in three turns between the magnetic base layer 1d and the non-magnetic base layer 1e. A loop conductor pattern 3d is provided in three turns between the non-magnetic base layer 1e and the magnetic base layer 1f. There is no loop conductor pattern provided between the magnetic base layer 1f and the magnetic base layer 1g. An annular gap 4 is provided between the magnetic base layer 1f and the magnetic base layer 1g instead. A loop conductor pattern 3e is provided in three turns between the magnetic base layer 1g and the magnetic base layer 1h. A loop conductor pattern 3f is provided in three turns between the magnetic base layer 1h and the magnetic base layer 1i. A loop conductor pattern 3g is provided in less than three turns between the magnetic base layer 1i and the magnetic base layer 1j.

Four surface electrodes 5a to 5d are provided separately at four corners of a first main surface (lower main surface) of the body 1. In some cases, an electronic component in which mounting electrodes are provided only on the lower main surface of the body is referred to as a LGA (Land grid array) type component. Four second dummy surface electrodes 6a to 6d that have no electrical connection and that increase a mounting strength are located near the center of the first main surface of the body 1. The second dummy surface electrodes are mechanically joined to a printed circuit board but have no electrical connection. The second dummy surface electrodes are connected to neither a signal line nor the ground after being mounted on, for example, a substrate. Accordingly, the second dummy surface electrodes do not greatly inhibit the magnetic field from being generated although the second dummy surface electrodes are disposed on the first main surface of the body 1. According to preferred embodiments of the present invention, the second dummy surface electrodes 6a to 6d are not essential and can be omitted.

Via conductors 7 are defined through the magnetic base layer 1a to 1d, the non-magnetic base layer 1e, and the magnetic base layers 1f to 1i so as to extend between both main surfaces thereof. The surface electrodes 5a and 5b are connected to the first distribution electrode 2a by using the corresponding via conductors 7. Similarly, the surface electrode 5c and 5d are connected to the second distribution electrode 2b by using the corresponding via conductors 7.

The first distribution electrode 2a, the loop conductor patterns 3a to 3g, and the second distribution electrode 2b are connected in this order by using the via conductors 7. According to the present preferred embodiment, the loop conductor patterns 3a to 3g are connected by using the corresponding via conductors 7 to form a coil conductor. Consequently, in the thin inductor 100, a coil is provided between the surface electrodes 5a and 5b and the surface electrodes 5c and 5d.

Examples of the main components of the first distribution electrode 2a, the second distribution electrode 2b, the loop conductor patterns 3a to 3g, and the via conductors 7 include silver. However, the materials thereof are not limited, and the main components may be copper or another metal. Plural metals may be contained therein, and the metals may be alloys.

The thin inductor 100 having the above structure according to the first preferred embodiment has the following features.

In the thin inductor 100, as illustrated in FIG. 3A, the four surface electrodes 5a to 5d are disposed separately at the four corners of the first main surface (lower main surface) of the body 1. The center P of each of the surface electrodes 5a to 5d is located in a region E in which the coil conductor (loop conductor patterns 3a to 3g) is provided when viewed in the stacking direction (direction in which the base layers are stacked) of the body 1. In the thin inductor 100, a surface electrode is divided into the two surface electrodes 5a and 5b, and another surface electrode is divided into the two surface electrodes 5c and 5d. Consequently, the area of each of the surface electrodes 5a to 5d is decreased. An increase in the area of each surface electrode increases the effect of the surface electrode to inhibit the formation of the magnetic field of the coil. The area of each of the surface electrodes 5a to 5d of the thin inductor 100 is decreased, and this reduces the degree of inhibition of the formation of the magnetic field due to the surface electrodes 5a to 5d.

In the case where the surface electrodes 5a to 5d are located inside the opening F of the coil when viewed in the stacking direction (direction in which the base layers are stacked) of the body 1, the magnetic field is inhibited from being generated more greatly than in the case where the surface electrodes 5a to 5d are located in the region E in which the coil conductor (loop conductor patterns 3a to 3g) is provided. In the thin inductor 100, the center P of each of the surface electrodes 5a to 5d is located in the region E, and this reduces the degree of inhibition of the formation of the magnetic field due to the surface electrodes 5a to 5d.

In the thin inductor 100, the surface electrodes 5a to 5d only slightly overlap the opening F of the coil. According to the present preferred embodiment, overlapping areas of the surface electrodes 5a to 5d and the opening F of the coil are equal to or less than about 3% of the area of the corresponding surface electrodes 5a to 5d. Most preferably, the surface electrodes 5a to 5d do not overlap the opening F of the coil. In the case where the surface electrodes 5a to 5d overlap the opening F of the coil, the overlapping areas are preferably as small as possible. In consideration for inhibition of the formation of the magnetic field, the overlapping areas are preferably equal to or less than about 10% of the area of the surface electrodes 5a to 5d. In the thin inductor 100, the overlapping areas of the surface electrodes 5a to 5d and the opening F of the coil are decreased to reduce the degree of inhibition of the formation of the magnetic field due to the surface electrodes 5a to 5d.

Thus, in the thin inductor 100, the degree of inhibition of the formation of the magnetic field by the coil conductor (loop conductor patterns 3a to 3g) due to the surface electrodes 5a to 5d is reduced to the minimum even though the thin inductor 100 has a narrow thickness of about 0.35 mm and the distances between the loop conductor pattern 3a and the surface electrodes 5a to 5d are short.

The area of the surface electrodes 5a to 5d is small, but the thin inductor 100 includes the four surface electrodes 5a to 5d. Accordingly, the thin inductor 100 is able to be firmly secured to an external electrode (such as a land electrode of a substrate), and a sufficient mounting strength is ensured. In the thin inductor 100, as illustrated in FIG. 3B, the first distribution electrode 2a and the second distribution electrode 2b are disposed mainly in the region E in which the coil conductor (loop conductor patterns 3a to 3g) is provided when viewed in the stacking direction (direction in which the base layers are stacked) of the body 1. In the case where the first distribution electrode 2a and the second distribution electrode 2b are disposed in the opening F of the coil, the magnetic field is inhibited from being generated more greatly than in the case where the first distribution electrode 2a and the second distribution electrode 2b are disposed in the region E in which the coil conductor (loop conductor patterns 3a to 3g) is provided. In the thin inductor 100, the first distribution electrode 2a and the second distribution electrode 2b are disposed mainly in the region E, and this reduces the degree of inhibition of the formation of the magnetic field due to the first distribution electrode 2a and the second distribution electrode 2b.

The body 1 of the thin inductor 100 is made of the magnetic base layers 1a to 1d and 1f to 1j and the non-magnetic base layer 1e. In the case where the body 1 is made of the magnetic base layers only, magnetic saturation is likely to occur when a large direct current flows, and there is a risk that an inductance value suddenly decreases. However, the body 1 of the thin inductor 100 includes the non-magnetic base layer 1e, and DC superposition characteristics are improved. Magnetic saturation is unlikely to occur even when a large direct current flows, and the inductance value does not suddenly decrease.

In the thin inductor 100, the annular gap 4 is provided between the magnetic base layer 1f and the magnetic base layer 1g. The gap 4 is arranged so as to almost overlap the region E in which the coil conductor (loop conductor patterns 3a to 3g) is provided when viewed in the stacking direction (direction in which the base layers are stacked) of the body 1. The present preferred embodiment, in which the body 1 is made of ceramics, needs a firing process in manufacturing processes. During cooling after firing, a stress may be produced between the base layers (magnetic base layers 1a to 1d and 1f to 1j and the non-magnetic base layer 1e) and the loop conductor patterns 3a to 3g due to a difference in coefficient of thermal shrinkage, and there is a risk of degradation of magnetic characteristics, such as a decrease in the magnetic permeability due to stress strain of the body 1 after firing. However, the gap provided in the body 1 relieves the stress produced between the base layers and the loop conductor patterns. The thin inductor 100, in which the gap 4 is located, relieves the stress produced between the base layers and the loop conductor patterns, and significantly reduces or prevents the degradation of the magnetic characteristics.

In the thin inductor 100, the second dummy surface electrodes 6a to 6d are separated from each other at four locations. In the case where the second dummy surface electrodes are not separated from each other and is combined into an electrode having a large area, there is a risk that, when the second dummy surface electrode is soldered to, for example, a land electrode of a substrate, the film thickness of the solder becomes too big, and this causes a mounting failure. In the thin inductor 100, a second dummy surface electrode is divided into the four second dummy surface electrodes 6a to 6d, and the area thereof is decreased to prevent the film thickness of the solder from becoming too big during soldering and reduce the occurrence of a mounting failure.

The thin inductor 100 having the above structure and features according to the present preferred embodiment can be manufactured by a typical existing method of manufacturing an inductor that includes a coil conductor in a body defined by base layers that are stacked. The thin inductor 100 can be manufactured by, for example, the following method.

Ceramic green sheets formed of, for example, magnetic ferrite are first prepared to form the magnetic base layers 1a to 1d and 1f to 1j. A ceramic green sheet formed of, for example, non-magnetic ferrite is prepared to form the non-magnetic base layer 1e.

Subsequently, holes are formed through the ceramic green sheets to form the via conductors 7 as needed. Subsequently, the formed holes are filled with a conductive paste. A conductive paste is applied to main surfaces of the ceramic green sheets so as to have a predetermined shape to form the loop conductor patterns 3a to 3g, the surface electrodes 5a to 5d, and the second dummy surface electrodes 6a to 6d as needed.

A material that is eliminated by firing is applied to a main surface (upper main surface) of one of the ceramic green sheets for forming the magnetic base layer 1f so as to have a predetermined shape to form the gap 4. Examples of the material that is eliminated by firing include a carbon paste.

The ceramic green sheets are stacked in a predetermined order and pressurized into one piece to obtain an unfired body. Subsequently, the unfired body is fired with a predetermined profile to complete the thin inductor 100 according to the first preferred embodiment. Plating may be performed on the surfaces of the surface electrodes 5a to 5d and the second dummy surface electrodes 6a to 6d.

### Second Preferred Embodiment

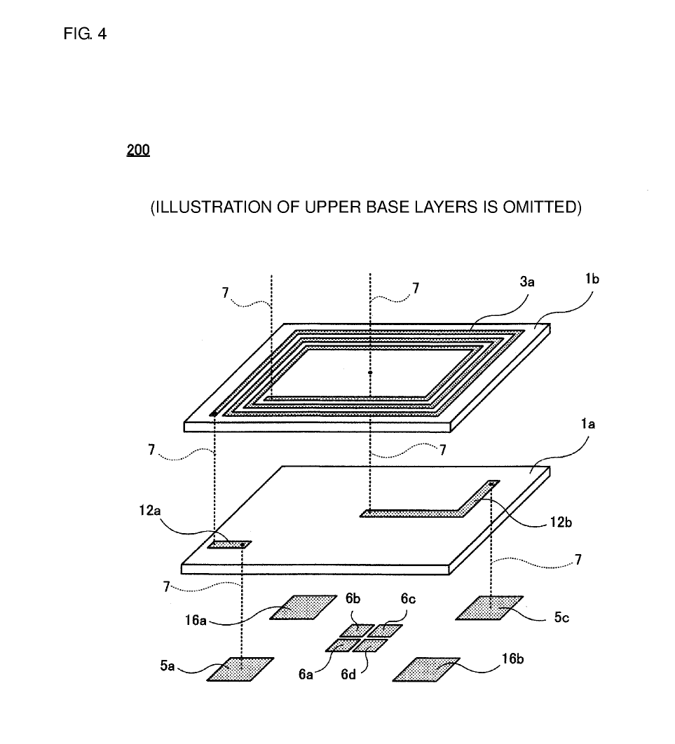

FIG. 4 illustrates a thin inductor 200 according to a second preferred embodiment of the present invention. FIG. 4 is an exploded perspective view of a main portion of the thin inductor 200.

The thin inductor 200 is preferably obtained by modifying a portion of the thin inductor 100 according to the first preferred embodiment. In the thin inductor 100, the two surface electrodes 5a and 5b are connected to the first distribution electrode 2a, and the two surface electrodes 5c and 5d are connected to the second distribution electrode 2b. In the thin inductor 200, the first distribution electrode 2a according to the first preferred embodiment is replaced with a first wiring electrode 12a having a different shape therefrom, and the second distribution electrode 2b according to the first preferred embodiment is replaced with a second wiring electrode 12b having a different shape therefrom. The surface electrode 5a alone is connected to the first wiring electrode 12a by using the via conductor 7. The surface electrode 5c alone is connected to the second wiring electrode 12b by using the via conductor 7.

The surface electrode 5b according to the first preferred embodiment is not connected to the first wiring electrode 12a and defines and functions as a first dummy surface electrode 16a that has no electrical connection. The surface electrode 5d according to the first preferred embodiment is not connected to the second wiring electrode 12b and defines and functions as a first dummy surface electrode 16b that has no electrical connection.

Remaining structures of the thin inductor 200 is preferably the same as in the thin inductor 100 according to the first preferred embodiment.

### Third Preferred Embodiment

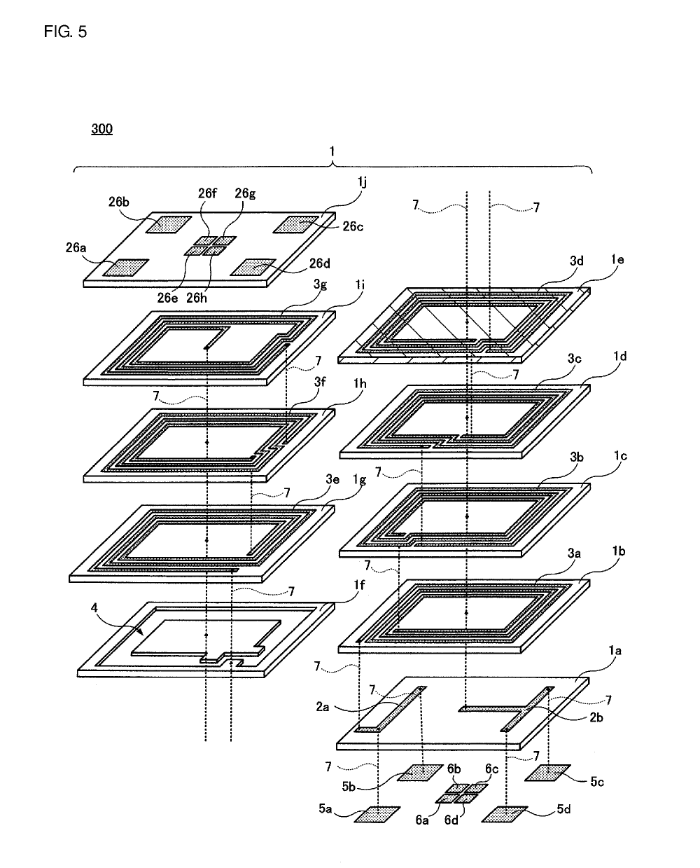

FIG. 5 illustrates a thin inductor 300 according to a third preferred embodiment of the present invention. FIG. 5 is an exploded perspective view of the thin inductor 300.

The thin inductor 300 is preferably obtained by adding a structure into the thin inductor 100 according to the first preferred embodiment.

The thin inductor 300 includes eight additional third dummy surface electrodes 26a to 26h that have no electrical connection on a second main surface (upper main surface) of the body 1 (magnetic base layer 1j). The third dummy surface electrodes 26a to 26h are disposed thereon to prevent the body 1 from warping during the firing process. More specifically, in the case where the electrodes (the surface electrodes 5a to 5d and the second dummy surface electrodes 6a to 6d) are provided only on the first main surface of the body 1 and no electrodes are provided on the second main surface of the body 1, the body 1 formed of ceramics, which needs the firing process in the manufacturing processes, carries a risk that the body 1 warps after firing due to a difference in the coefficient of thermal shrinkage between both main surfaces of the body 1. In the thin inductor 300, the third dummy surface electrodes 26a to 26h are provided on the second main surface of the body 1, this equalizes the coefficients of thermal shrinkage of both main surfaces of the body 1, and the body 1 is inhibited from warping during the firing process.

The third dummy surface electrodes 26a to 26h are arranged so as to overlap the surface electrodes 5a to 5d and the second dummy surface electrodes 6a to 6d when the body 1 is viewed in the stacking direction (stacking direction of the body). The purpose of this is to reduce the degree of inhibition of the formation of the magnetic field to the minimum. That is, in the case where the third dummy surface electrodes 26a to 26h are arranged so as not to overlap the surface electrodes 5a to 5d and the second dummy surface electrodes 6a to 6d, a portion of the magnetic flux is blocked by the surface electrodes 5a to 5d and the second dummy surface electrodes 6a to 6d on the first main surface of the body 1, and another portion of the magnetic flux is blocked by the third dummy surface electrodes 26a to 26h on the second main surface of the body 1. Consequently, these electrodes greatly inhibit the magnetic field from being generated. However, in the case where the third dummy surface electrodes 26a to 26h are arranged so as to overlap the surface electrodes 5a to 5d and the second dummy surface electrodes 6a to 6d, although the portion of the magnetic flux blocked by the surface electrodes 5a to 5d and the second dummy surface electrodes 6a to 6d on the first main surface of the body 1 is also blocked by the third dummy surface electrodes 26a to 26h on the second main surface of the body 1, a portion of the magnetic flux that is not blocked by the surface electrodes 5a to 5d and the second dummy surface electrodes 6a to 6d on the first main surface of the body 1 is also not blocked by the third dummy surface electrodes 26a to 26h on the second main surface of the body. That is, in the thin inductor 300, the portion of the magnetic flux blocked by the surface electrodes 5a to 5d and the second dummy surface electrodes 6a to 6d on the first main surface of the body 1 is common to the portion of the magnetic flux blocked by the third dummy surface electrodes 26a to 26h on the second main surface of the body, and this ensures a sufficient amount of the magnetic flux that is blocked neither by the surface electrodes 5a to 5d and the second dummy surface electrodes 6a to 6d on the first main surface of the body nor by the third dummy surface electrodes 26a to 26h on the second main surface of the body, and reduces the degree of inhibition of the formation of the magnetic field due to the surface electrodes 5a to 5d, the second dummy surface electrodes 6a to 6d, and the third dummy surface electrodes 26a to 26h to the minimum.

Remaining structures of the thin inductor 300 are preferably the same as in the thin inductor 100 according to the first preferred embodiment.

### Fourth Preferred Embodiment

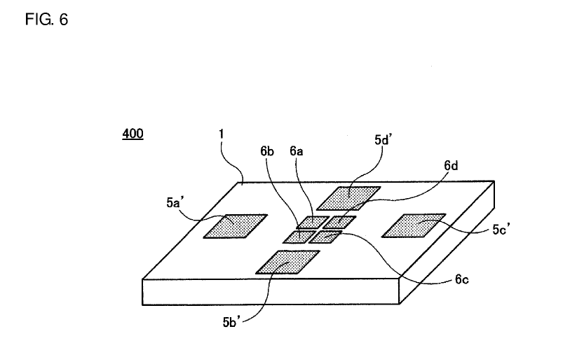

FIG. 6 illustrates a thin inductor 400 according to a fourth preferred embodiment of the present invention. FIG. 6 is a perspective view of the thin inductor 400 from the lower main surface side (first main surface side).

The thin inductor 400 is preferably obtained by modifying a portion of the thin inductor 100 according to the first preferred embodiment.

Specifically, in the thin inductor 100, the four surface electrodes 5a to 5d are disposed separately at the four corners of the lower main surface (first main surface) of the body 1. Compared with this, in the thin inductor 400, four surface electrodes 5a′ to 5d′ are disposed at middle positions of the four sides of the lower main surface (first main surface) of the body 1.

Remaining structures of the thin inductor 400 are preferably the same as in the thin inductor 100 according to the first preferred embodiment.

Thus, the positions at which the surface electrodes are provided are able to be appropriately adjusted.

The thin inductors 100 to 400 according to the first preferred embodiment to the fourth preferred embodiment are described above. However, the present invention is not limited to the above description. Various modifications can be made within the spirit of the present invention.

For example, the thickness of each of the thin inductors 100 to 400 preferably is about 0.35 mm but is not limited thereto. The thickness can be freely selected from values of about 0.5 mm or less.

The body 1 of each of the thin inductors 100 to 400 is preferably made of ceramics. However, the material of the body 1 is not limited, and the body 1 may be made of, for example, a resin.

In the thin inductors 100 to 400, the loop conductor patterns 3a to 3g are preferably provided in three turns or less than three turns. However, the number of turns and shape of the loop conductor patterns 3a to 3g are not limited. For example, the number of turns may be one, two, or four or more. The shape of the loop conductor patterns 3a to 3g may be changed.

The number of the base layers (magnetic base layers 1a to 1d and 1f to 1j and the non-magnetic base layer 1e) included in the body 1 and the number of the loop conductor patterns 3a to 3g are not limited to the above description and may be increased or decreased.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An inductor comprising:
a rectangular or substantially rectangular thin sheet body that includes base layers and that has a thickness of about 0.5 mm or less;
a coil conductor that is disposed in the body and that has a winding axis in a direction in which the base layers are stacked;
four surface electrodes that are provided on a first main surface of the body; and
a first wiring electrode and a second wiring electrode that are provided between the base layers near the first main surface of the body; wherein
a first end of the coil conductor is connected to at least one of the surface electrodes with the first wiring electrode interposed therebetween, and a second end of the coil conductor is connected to at least one of the other surface electrodes with the second wiring electrode interposed therebetween;
a center of each of the four surface electrodes is located in a region in which the coil conductor is located when viewed in the direction in which the base layers are stacked; and
the first wiring electrode and the second wiring electrode are disposed mainly in the region in which the coil conductor is provided when viewed in the direction in which the base layers are stacked.

2. The inductor according to claim 1, wherein the four surface electrodes are disposed separately at four corners of the first main surface of the body.

3. The inductor according to claim 1, wherein each of the four surface electrodes does not overlap an opening of the coil conductor, or overlaps the opening of the coil conductor with an overlapping area being equal to or less than about 10% of an area of the surface electrode when viewed in the direction in which the base layers are stacked.

4. The inductor according to claim 1, wherein the first end of the coil conductor is connected to two surface electrodes of the surface electrodes, and the second end of the coil conductor is connected to the other two surface electrodes.

5. The inductor according to claim 4, wherein
the first wiring electrode includes a first distribution electrode;
the second wiring electrode includes a second distribution electrode; and
the first end of the coil conductor is connected to the first distribution electrode, the first distribution electrode is connected to the two surface electrodes, the second end of the coil conductor is connected to the second distribution electrode, and the second distribution electrode is connected to the other two surface electrodes.

6. The inductor according to claim 1, wherein
the first end of the coil conductor is connected to one of the surface electrodes, the second end of the coil conductor is connected to one of the other surface electrodes; and
the other two surface electrodes to which the coil conductor is not connected are first dummy surface electrodes that have no electrical connection and that increase a mounting strength.

7. An inductor comprising:
a rectangular or substantially rectangular thin sheet body that includes base layers stacked and that has a thickness of about 0.5 mm or less;
a coil conductor that is disposed in the body and that has a winding axis in a direction in which the base layers are stacked;
four surface electrodes that are provided on a first main surface of the body; and
a first distribution electrode and a second distribution electrode that are provided between the base layers near the first main surface of the body; wherein
a first end of the coil conductor is connected to two surface electrodes of the four surface electrodes, and a second end of the coil conductor is connected to the other two surface electrodes;
the four surface electrodes are disposed separately at four corners of the first main surface of the body;
the first end of the coil conductor is connected to the first distribution electrode, the first distribution electrode is connected to the two surface electrodes, the second end of the coil conductor is connected to the second distribution electrode, and the second distribution electrode is connected to the other two surface electrodes; and
the first distribution electrode and the second distribution electrode are disposed mainly in a region in which the coil conductor is provided when viewed in the direction in which the base layers are stacked.

8. The inductor according to claim 7, wherein each of the four surface electrodes does not overlap an opening of the coil conductor, or overlaps the opening of the coil conductor with an overlapping area being equal to or less than about 10% of an area of the surface electrode when viewed in the direction in which the base layers are stacked.

9. The inductor according to claim 1, wherein a second dummy surface electrode that does not have any electrical connection and that increases a mounting strength is provided on the first main surface of the body so as to overlap a cavity of a coil.

10. The inductor according to claim 9, wherein the second dummy surface electrode is divided into plural second dummy surface electrodes.

11. The inductor according to claim 1, wherein the body is made of ceramics, and a third dummy surface electrode that does not have any electrical connections is provided on a second main surface of the body.

12. The inductor according to claim 11, wherein the thin inductor includes a plurality of the third dummy surface electrodes, the plurality of the third dummy surface electrodes are arranged so as to overlap the surface electrodes, are arranged so as to overlap the surface electrodes and the first dummy surface electrode, are arranged so as to overlap the surface electrodes and the second dummy surface electrode, or are arranged so as to overlap the surface electrodes, the first dummy surface electrode, and the second dummy surface electrode when viewed in the direction in which the base layers are stacked.

13. The inductor according to claim 1, wherein the base layers of the body are made of magnetic base layers and at least one non-magnetic base layer, and the at least one non-magnetic base layer is interposed and stacked between two of the magnetic base layers.

14. The inductor according to claim 1, wherein
the body is made of ceramics, at least one layer of a gap extending in a direction perpendicular or substantially perpendicular to the direction in which the base layers are stacked is provided in the body; and
the gap overlaps the region in which the coil conductor is provided when viewed in the direction in which the base layers are stacked.

15. A surface-mount thin inductor comprising:
a rectangular or substantially rectangular thin sheet body that includes base layers and that has a thickness of about 0.5 mm or less;
a coil conductor that is disposed in the body and that has a winding axis in a direction in which the base layers are stacked; and
four surface electrodes that are on a first main surface of the body; wherein
a first end of the coil conductor is connected to two surface electrodes of the surface electrodes, and a second end of the coil conductor is connected to the other two surface electrodes; and
a center of each of the four surface electrodes is located in a region in which the coil conductor is provided when viewed in the direction in which the base layers are stacked.

16. The inductor according to claim 3, wherein each of the four surface electrodes overlaps a portion of the opening of the coil conductor with an overlapping area being equal to or less than about 3% of an area of the surface electrode when viewed in the direction in which the base layers are stacked.

17. The inductor according to claim 3, wherein no portion of any of the four surface electrodes overlaps any portion of the opening of the coil conductor.

18. The inductor according to claim 12, wherein the plurality of the third dummy surface electrodes includes eight dummy surface electrodes which overlap corresponding electrodes provided on the first main surface of the body.

19. The inductor according to claim 1, wherein the four surface electrodes are disposed at middle positions of four sides of the first main surface of the body.

20. The inductor according to claim 1, wherein the coil conductor includes a plurality of loop conductor patterns provided on individual layers, and a total number of turns of each individual one of the plurality of loop conductor patterns is three or less.
